(19) United States
(12) Patent Application Publication
(10) Pub. No.: US 2017/0307222 A1
(43) Pub. Date: Oct. 26, 2017

(54) SPIKED FIRE POKER

(71) Applicant: Kirk D. Snyder, Roachdale, IN (US)

(72) Inventor: Kirk D. Snyder, Roachdale, IN (US)

(21) Appl. No.: 15/494,434

(22) Filed: Apr. 21, 2017

Related U.S. Application Data
(60) Provisional application No. 62/325,871, filed on Apr. 21, 2016.

(51) Int. Cl. F24B 15/00; B23P 15/00

(52) U.S. Cl. CPC F24B 15/002; B23P 15/00

(57) ABSTRACT

A spiked fire poker that easily manipulates wood and other objects in a burning fire. The spiked fire poker includes an elongated shaft grasped by a person to utilize the spiked fire poker and a spiked fire poker head having a first end and a second end, the first end of the poker head shaft having an aperture disposed on the first end of the poker head shaft to receive a first end of the elongated handle that is inserted into the aperture, the spiked fire poker head attached to the second end of the poker head shaft, the spiked fire poker head having a top prong, a left-sided head piece, a middle head piece and a right-sided head piece. The spiked fire poker also includes a corresponding method for manufacturing a spiked fire poker.

### BACKGROUND OF THE INVENTION

This application claims priority to U.S. Provisional application No. filed on, the entire disclosure of which is incorporated by reference.

### 1. FIELD OF THE INVENTION

The present invention relates to a fire poker. More specifically, the present invention relates to a spiked fire poker.

### 2. DESCRIPTION OF THE RELATED ART

Fires have always been an important part of daily life. The role of fire in everyday life has changed as civilization and technology has developed, where people no longer need fire as a part of survival. However, people still utilize fire for recreational purposes such as for camp fires, fireplaces and other recreation uses.

Tools are needed to ensure control of the fire, even for recreational purposes. Often people will utilize a fire poker to move wood and other items being burned in the fire. Often, these fire pokers are very simple sticks that are not very effective and may be improved.

What is needed is a spiked fire poker that easily manipulates wood and other objects in a burning fire.

### SUMMARY OF THE INVENTION

The present invention relates to a fire poker. More specifically, the present invention relates to a spiked fire poker.

The spiked fire poker includes an elongated shaft grasped by a person to utilize the spiked fire poker and a spiked fire poker head having a first end and a second end, the first end of the poker head shaft having an aperture disposed on the first end of the poker head shaft to receive a first end of the elongated handle that is inserted into the aperture, the spiked fire poker head attached to the second end of the poker head shaft, the spiked fire poker head having a top prong, a left-sided head piece, a middle head piece and a right-sided head piece.

It is an object of the present invention to provide a spiked fire poker that may grab the edges of wood or other objects in a burning fire and move them around to facilitate stoking the burning fire.

It is an object of the present invention to provide a spiked fire poker that includes a plurality of multiple spikes disposed on a spiked fire poker head that may fit in-between spaces and may grab the edges of the wood or other objects in order to stoke the fire more easily.

It is an object of the present invention to provide a spiked fire poker that the circular shape with multiple small squared points to have a better grabbing ability to push and pull in all directions, even sideways.

It is an object of the present invention to provide a spiked fire poker that may also be utilized to clear brushy and weedy areas by spinning weeds or other vegetation around the spiked fire poker head and pulling them out.

It is an object of the present invention to provide a spiked fire poker that may also be a wild animal deterrent to keep wild animals away.

### BRIEF DESCRIPTION OF THE DRAWINGS

The present invention will be described by way of exemplary embodiments, but not limitations, illustrated in the accompanying drawings in which like references denote similar elements, and in which:

FIG. 1 illustrates a side perspective view of a spiked fire poker, in accordance with one embodiment of the present invention.

FIG. 2 illustrates a second side perspective view of a spiked fire poker head, in accordance with one embodiment of the present invention.

FIG. 3 illustrates a flowchart of a method for manufacturing a spiked fire poker, in accordance with one embodiment of the present invention.

### DETAILED DESCRIPTION OF THE INVENTION

Various aspects of the illustrative embodiments will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative embodiments. However, it will be apparent to one skilled in the art that the present invention may be practiced without the specific details. In other instances, well-known features are omitted or simplified in order not to obscure the illustrative embodiments.

Various operations will be described as multiple discrete operations, in turn, in a manner that is most helpful in understanding the present invention however the order of description should not be construed as to imply that these operations are necessarily order dependent. In particular, these operations need not be performed in the order of presentation.

The phrase “in one embodiment” is used repeatedly. The phrase generally does not refer to the same embodiment, however, it may. The terms “comprising”, “having” and “including” are synonymous, unless the context dictates otherwise.

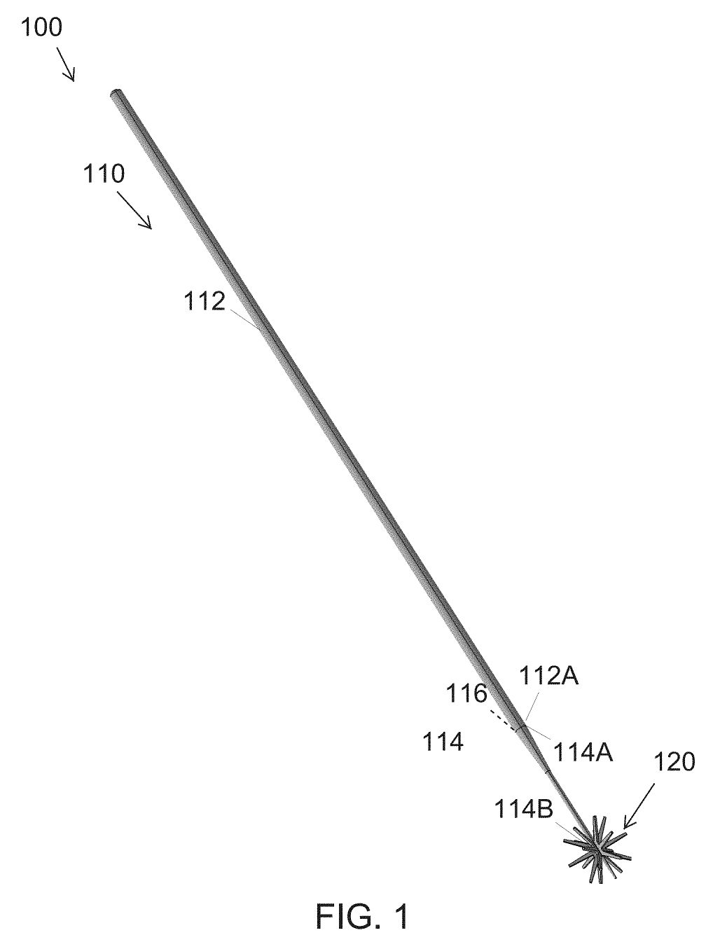

FIG. 1 illustrates a side perspective view of a spiked fire poker 100, in accordance with one embodiment of the present invention.

The spiked fire poker 100 may have an elongated shaft 110 and a spiked fire poker head 120.

The elongated shaft 110 may include an elongated handle 112 and a poker head shaft 114. The elongated handle 112 may be grasped by a person to utilize the spiked fire poker 100. The elongated handle 112 may be cylindrical to facilitate grasping. The elongated handle 112 may be made of material selected from the group consisting of wood, fiberglass, aluminum or steel. The poker head shaft 114 may have a first end 114A and a second end 114B. The first end 114A of the poker head shaft 114 may have an aperture 116 disposed on the first end 114A of the poker head shaft 114 to receive a first end 112A of the elongated handle 112 that is inserted into the aperture 116. The poker head shaft 114 may be made of material selected from the group consisting of metal, aluminum or steel.

The spiked fire poker head 120 may be attached to the second end 114B of the poker head shaft 114.

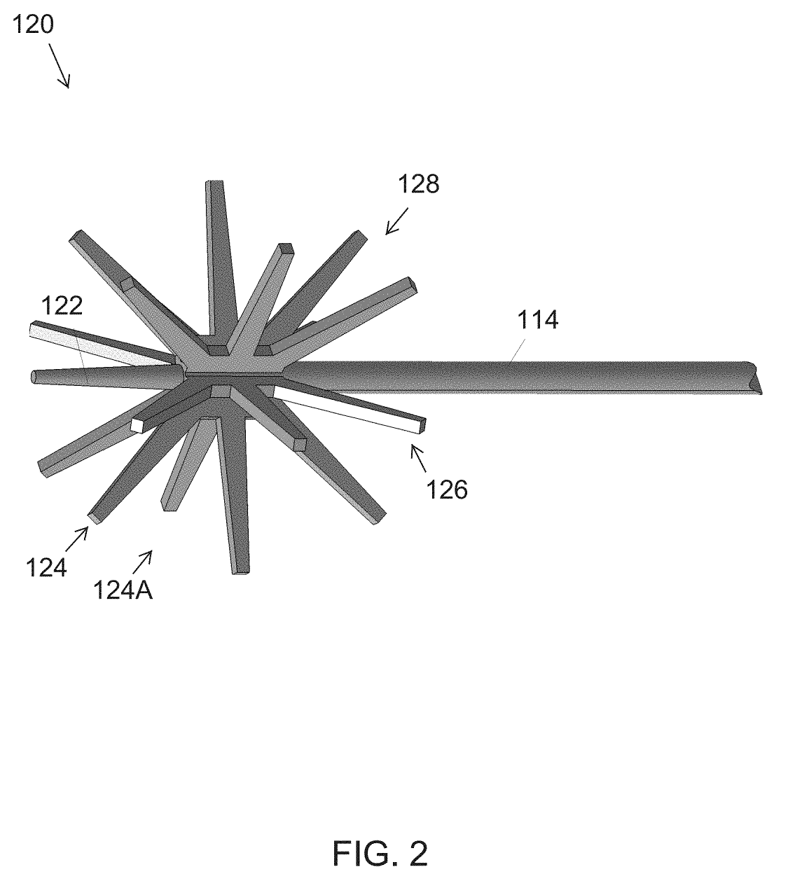

FIG. 2 illustrates a second side perspective view of a spiked fire poker head 120, in accordance with one embodiment of the present invention.

The spiked fire poker head 120 may have a top prong 122, a left-sided head piece 124, a middle head piece 126 and a right-sided head piece 128. The left-sided head piece 124 may include six prongs 124A that extend outward at approximately 45 degrees, approximately 90 degrees and approximately 135 degrees. The poker head shaft 114 may be tapered downward to allow the spiked fire poker head 120 to reach into confined spaces. The spiked fire poker head 120 may be made of material selected from the group consisting of metal, aluminum or steel.

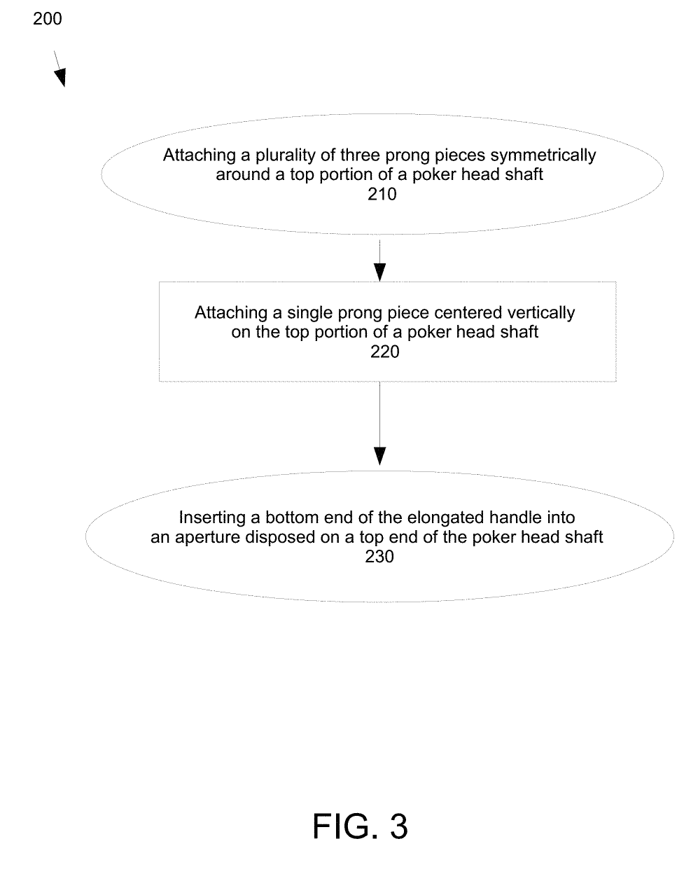

FIG. 3 illustrates a flowchart of a method for manufacturing a spiked fire poker 200, in accordance with one embodiment of the present invention.

The method for manufacturing 200 may include the steps of attaching a plurality of three prong pieces symmetrically around a top portion of a poker head shaft 210, attaching a single prong piece centered vertically on the top portion of a poker head shaft 220 and inserting a bottom end of the elongated handle into an aperture disposed on a top end of the poker head shaft 230.

The first attaching step 210 may include welding the three prong pieces symmetrically around the top portion of a poker head shaft. The first attaching step 210 may include fusing the three prong pieces symmetrically around the top portion of a poker head shaft. The second attaching step 220 may include welding the single prong piece centered vertically on the top portion of the poker head shaft. The second attaching step 220 may include fusing the single prong piece centered vertically on the top portion of the poker head shaft. The inserting step 230 may include the poker head shaft is made of material selected from the group consisting of metal, aluminum or steel. The inserting step 230 may include the elongated handle is made of material selected from the group consisting of wood, fiberglass, aluminum or steel.

While this invention has been described in conjunction with the various exemplary embodiments outlined above, it is evident that many alternatives, modifications and variations will be apparent to those skilled in the art. Accordingly, the exemplary embodiments of the invention, as set forth above, are intended to be illustrative, not limiting. Various changes may be made without departing from the spirit and scope of the invention.

What is claimed is:

1. A spiked fire poker, comprising:
an elongated shaft grasped by a person to utilize the spiked fire poker; and
a spiked fire poker head having a first end and a second end, the first end of the poker head shaft having an aperture disposed on the first end of the poker head shaft to receive a first end of the elongated handle that is inserted into the aperture, the spiked fire poker head attached to the second end of the poker head shaft, the spiked fire poker head having a top prong, a left-sided head piece, a middle head piece and a right-sided head piece.

2. The spiked fire poker according to claim 1, wherein the elongated shaft is cylindrical to facilitate grasping.

3. The spiked fire poker according to claim 1, wherein the elongated handle is made of material selected from the group consisting of wood, fiberglass, aluminum or steel.

4. The spiked fire poker according to claim 1, wherein the left-sided head piece includes six prongs that extend outward at 45 degrees, 90 degrees and 135 degrees.

5. The spiked fire poker according to claim 1, wherein the poker head shaft tapered downward to allow the spiked fire poker head to reach into confined spaces.

6. The spiked fire poker according to claim 1, wherein the spiked fire poker head is made of material selected from the group consisting of metal, aluminum or steel.

7. The spiked fire poker according to claim 1, wherein the poker head shaft is made of material selected from the group consisting of metal, aluminum or steel.

8. A method for manufacturing a spiked fire poker, comprising the steps of:
attaching a plurality of three prong pieces symmetrically around a top portion of a poker head shaft;
attaching a single prong piece centered vertically on the top portion of a poker head shaft; and
inserting a bottom end of the elongated handle into an aperture disposed on a top end of the poker head shaft.

9. The method for manufacturing a spiked fire poker according to claim 8, wherein the first attaching step includes welding the three prong pieces symmetrically around the top portion of a poker head shaft.

10. The method for manufacturing a spiked fire poker according to claim 8, wherein the first attaching step includes fusing the three prong pieces symmetrically around the top portion of a poker head shaft.

11. The method for manufacturing a spiked fire poker according to claim 8, wherein the second attaching step includes welding the single prong piece centered vertically on the top portion of the poker head shaft.

12. The method for manufacturing a spiked fire poker according to claim 8, wherein the second attaching step includes fusing the single prong piece centered vertically on the top portion of the poker head shaft.

13. The method for manufacturing a spiked fire poker according to claim 8, wherein the inserting step includes the poker head shaft is made of material selected from the group consisting of metal, aluminum or steel.

14. The method for manufacturing a spiked fire poker according to claim 8, wherein the inserting step includes the elongated handle is made of material selected from the group consisting of wood, fiberglass, aluminum or steel.
